(19) United States
(12) Patent Application Publication
(10) Pub. No.: US 2011/0241256 A1
(43) Pub. Date: Oct. 6, 2011

(54) DECURLING METHOD AND APPARATUS, AND FILM PRODUCTION METHOD

(75) Inventor: HIROSHI MIYACHI, KANAGAWA (JP)

(73) Assignee: FUJIFILM CORPORATION, TOKYO (JP)

(21) Appl. No.: 13/076,868

(22) Filed: Mar. 31, 2011

(30) Foreign Application Priority Data
Mar. 31, 2010 (JP) 2010-081783

(51) Int. Cl. B29C 53/18

(52) U.S. Cl. 264/346; 425/403.1

(57) ABSTRACT

A continuous multi-layer film has first and second film surfaces and having a curling tendency to direct the first film surface inwards. For decurling, a decurling apparatus includes a cover body for covering a moving path through which the multi-layer film is moved longitudinally. A water vapor source is contained in the cover body, for supplying water vapor to contact a surface layer portion in the multi-layer film disposed on the second film surface, to apply heat to set the surface layer portion at a higher temperature than a glass transition temperature thereof. A cooling device is contained in the cover body, disposed downstream of the water vapor source adjacently, for cooling the multi-layer film of which the surface layer portion is set at the higher temperature, to set temperature of the multi-layer film at 50 deg. C. or lower within 2 seconds.

### BACKGROUND OF THE INVENTION

1. Field of the Invention

The present invention relates to a decurling method and apparatus, and film production method. More particularly, the present invention relates to a decurling method and apparatus in which a multi-layer film can be decurled efficiently even with a simple structure of devices, and film production method for the multi-layer film.

2. Description Related to the Prior Art

Cellulose acylate film is a polymer film having good performance with transparent and soft property. Various uses of the polymer film are known, including a window laminate, touch panel film, film for an ITO board, membrane switch film, three dimensional decorative film, optical functional film for a flat panel display panel, and the like.

Those uses are classified in two types. In a first type, a surface of the polymer film is touched by a finger, fabric, touch pen or the like. In a second type, the surface of the polymer film is rubbed by a finger, fabric, touch pen or the like. There occurs a problem of possible scratch on the surface of the polymer film. To solve this problem, a hard coat layer is formed on the polymer film with a higher hardness than the polymer film.

An example of method of producing a multi-layer film including the hard coat layer formed on the polymer film. In a first step of coating application or coating step, a surface of the polymer film is coated with a material curable with curing energy such as ultraviolet radiation, to form a layer. Then in a drying step, the layer is dried. In a step of curing or energy application, the curing energy is applied to the layer. The layer becomes the hard coat layer upon application of the curing energy. The multi-layer film is obtained as a product.

However, there occurs a curl in the multi-layer film in the polymerization in a manner to direct the hard coat layer inwards. To decurl the multi-layer film, JP-A 2005-111315 discloses a method of vapor supply step to apply water vapor to the multi-layer film.

To produce the multi-layer film in a large scale, the coating application, the curing and the vapor supply step are carried out consecutively. To decurl the multi-layer film, water vapor must be blown to the multi-layer film for a predetermined time.

A water vapor contact device for the vapor supply step should be elongated in the moving direction according to highness of the moving speed of the support film, for example, 20 m/min or more. However, it is impossible in the method of JP-A to raise efficiency in producing the multi-layer film and also to economize a space for installing the water vapor contact device for decurling the multi-layer film.

### SUMMARY OF THE INVENTION

In view of the foregoing problems, an object of the present invention is to provide a decurling method and apparatus in which a multi-layer film can be decurled efficiently even with a simple structure of devices, and film production method for the multi-layer film.

In order to achieve the above and other objects and advantages of this invention, a decurling method for a continuous multi-layer film having at least first and second layers and having a curling tendency to direct the first layer inwards is provided. The decurling method includes moving the multi-layer film longitudinally. During movement of the multi-layer film, water vapor is supplied to contact a surface layer portion in the second layer, to apply heat to set the surface layer portion at a higher temperature than a glass transition temperature thereof. During movement of the multi-layer film and immediately after the vapor supply step, the multi-layer film of which the surface layer portion is set at the higher temperature is cooled, so as to set temperature of the multi-layer film at 50 deg. C. or lower within 2 seconds from a start thereof.

The second layer is a support layer, and the first layer is a hard coat layer overlaid on the support layer.

In the cooling step, the second layer is cooled for the multi-layer film.

In the cooling step, cooling gas is applied to the surface layer portion.

The cooling gas contains water vapor.

In the cooling step, water molecules are used to cool the multi-layer film.

In the cooling step, cooling liquid is caused to contact the surface layer portion.

The cooling liquid is water.

In the cooling step, a liquid reservoir storing cooling liquid is used, and the multi-layer film is introduced into the cooling liquid in the liquid reservoir by a guide roller.

Preferably, in the cooling step, the multi-layer film is moved by a transport roller having a peripheral surface for supporting the surface layer portion. Temperature of the peripheral surface is set lower than temperature of the surface layer portion by a value equal to or more than 10 deg. C. and equal to or less than 90 deg. C.

Also, a film production method for a continuous multi-layer film having first and second film surfaces and having a curling tendency to direct the first film surface inwards is provided. The film production method includes moving the multi-layer film longitudinally. During movement of the multi-layer film, water vapor is supplied to contact a surface layer portion in the multi-layer film disposed on the second film surface, to apply heat to set the surface layer portion at a higher temperature than a glass transition temperature thereof. During movement of the multi-layer film and immediately after the vapor supply step, the multi-layer film of which the surface layer portion is set at the higher temperature is cooled, so as to set temperature of the multi-layer film at 50 deg. C. or lower within 2 seconds from a start thereof.

Also, a decurling apparatus for a continuous multi-layer film having first and second film surfaces and having a curling tendency to direct the first film surface inwards is provided. A cover body covers a moving path through which the multi-layer film is moved longitudinally. A water vapor source is contained in the cover body, for supplying water vapor to contact a surface layer portion in the multi-layer film disposed on the second film surface, to apply heat to set the surface layer portion at a higher temperature than a glass transition temperature thereof. A cooling device is contained in the cover body, disposed downstream of the water vapor source adjacently, for cooling the multi-layer film of which the surface layer portion is set at the higher temperature, so as to set temperature of the multi-layer film at 50 deg. C. or lower within 2 seconds from a start thereof. The multi-layer film includes a support layer having the second film surface on one side. A coating layer is overlaid on the support layer on a side opposite to the second film surface, and having the first film surface.

The cooling device cools the second film surface of the multi-layer film.

The cooling device applies cooling gas to the surface layer portion.

The cooling device includes a cooling gas supply source for discharging the cooling gas. A gas adjuster adjusts temperature and humidity of the cooling gas.

Preferably, the cooling device includes a transport roller, having a peripheral surface, for supporting the surface layer portion and moving the multi-layer film. A controller sets temperature of the peripheral surface lower than temperature of the surface layer portion by a value equal to or more than 10 deg. C. and equal to or less than 90 deg. C.

Preferably, the cooling device includes a liquid reservoir for storing cooling liquid. A guide roller introduces the multi-layer film into the cooling liquid in the liquid reservoir.

Accordingly, a multi-layer film can be decurled efficiently even with a simple structure of devices, because the cooling is immediately after the vapor supply step and carried out very quickly.

### BRIEF DESCRIPTION OF THE DRAWINGS

The above objects and advantages of the present invention will become more apparent from the following detailed description when read in connection with the accompanying drawings, in which:

FIG. 1 is a plan illustrating multi-layer film;

FIG. 2 is a side elevation illustrating a film production system;

FIG. 3 is a vertical section illustrating a decurling apparatus;

FIG. 4A is a front elevation illustrating the multi-layer film;

FIG. 4B is a front elevation illustrating the multi-layer film in a vapor supply step;

FIG. 4C is a front elevation illustrating the multi-layer film after a cooling step;

FIG. 5 is a vertical section illustrating one decurling apparatus having a plurality of transport rollers for cooling;

FIG. 6 is a vertical section illustrating another decurling apparatus having a contact water reservoir;

FIG. 7 is a vertical section illustrating still another decurling apparatus having a cooling gas supply source;

FIG. 8 is a side elevation illustrating a test film piece for measurement of a curl.

### DETAILED DESCRIPTION OF THE PREFERRED EMBODIMENT(S) OF THE PRESENT INVENTION

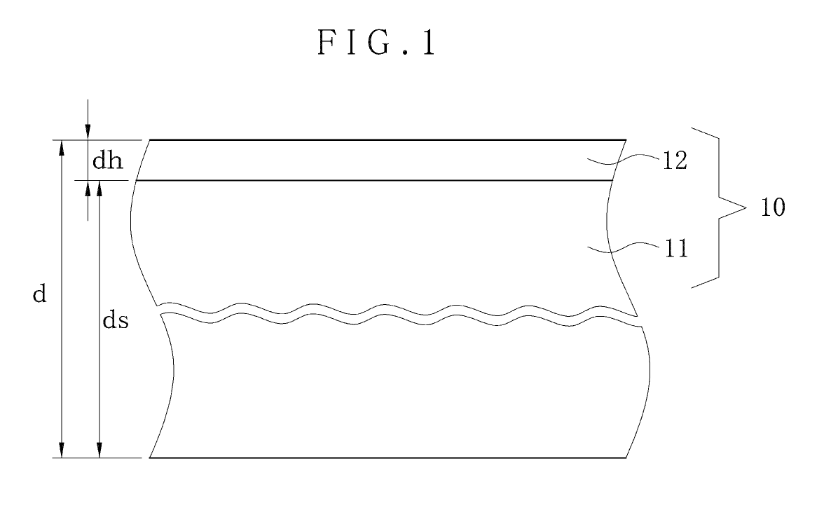

In FIG. 1, a multi-layer film 10 includes a support layer 11 and a hard coat layer 12 (coating layer) having a higher hardness than the support layer 11. A thickness d of the multi-layer film 10 is not limited, but preferably equal to or more than 5 microns and equal to or less than 120 microns, and more preferably equal to or more than 40 microns and equal to or less than 80 microns. A ratio dh/ds between a thickness ds of the support layer 11 to a thickness dh of the hard coat layer 12 is preferably equal to or more than 0.04 and equal to or less than 0.50, and more preferably equal to or more than 0.10 and equal to or less than 0.40.

To impart anti-reflection property to the multi-layer film 10, the refractive index of the hard coat layer 12 in the invention is in a range of 1.45-2.00, preferably in a range of 1.45-1.55, more preferably in a range of 1.48-1.55, and still more preferably in a range of 1.49-1.53. By controlling the refractive index of the hard coat layer 12 in this manner, the multi-layer film 10 can be obtained with an effectively reduced reflectance of the film surface and with a neutral color range of reflection. Also, it is possible by the control of the refractive index to prevent interference unevenness, namely a failure due to a difference in the refractive index between the support layer 11 and the hard coat layer 12.

Hardness of the hard coat layer 12 is, in the pencil hardness test, preferably 2H or more, more preferably 3H or more, and most preferably 4H or more. The amount of abrasion wear of a sample piece with the hard coat layer 12, in the Taber abrasion test according to JIS K 5400, is preferably as small as possible after the test.

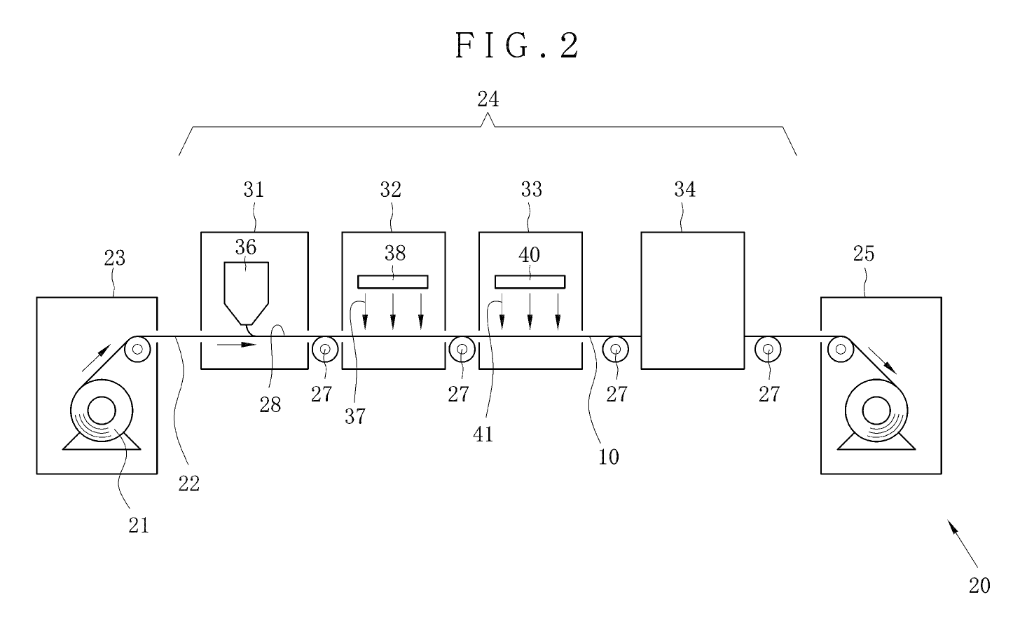

In FIG. 2, a multi-layer film production system 20 produces the multi-layer film 10. The multi-layer film production system 20 includes a film dispenser 23, a moving path 24, and a film winder 25. There is a support film roll 21 from which support film 22 is advanced by the film dispenser 23. In the moving path 24, the multi-layer film 10 is produced from the support film 22. The film winder 25 winds the multi-layer film 10 from the moving path 24 in a roll form. A plurality of transport rollers 27 as moving device are arranged on the moving path 24 from the film dispenser 23 toward the film winder 25.

[Support Film]

Materials for the support film 22 have optical transmittance, and are not limited particularly. Preferable examples of the materials are polymers, for example, cellulose acylates, cyclic polyolefins, lactone ring-containing polymers, polyolefins, polycarbonate, and the like. Details of the cellulose acylates will be described later.

Plural devices are arranged on the moving path 24 from the film dispenser 23 toward the film winder 25, including a coater 31 for layer forming, a dryer 32, an ultraviolet irradiator 33 or polymerizer, and a decurling apparatus 34 or decurler. The coater 31 forms an ultraviolet curable layer 28 on the support film 22, the layer 28 containing a solvent and an ultraviolet curable compound. The dryer 32 dries the layer 28 by evaporating the solvent. The ultraviolet irradiator 33 applies ultraviolet rays to the layer 28 for curing the ultraviolet curable compound. The decurling apparatus 34 removes a curl created with the multi-layer film 10 in the course of ultraviolet radiation.

A coating die 36 is incorporated in the coater 31, and discharges the coating solution. The coating die 36 coats a surface of the support film 22 with the coating solution, to form the layer 28 on the support film 22. For preparation, the coating solution is formed from solvent of a suitable type and an ultraviolet curable compound dissolved or dispersed colloidally therein. A density of the ultraviolet curable compound can be determined for a purpose, and is preferably in a range equal to or more than 10 wt. % and equal to or less than 95 wt. %.

[Ultraviolet Curable Compounds]

Preferable examples of the ultraviolet curable compounds are polyfunctional monomers and oligomers of an ionizing radiation curable property. Functional groups of the polyfunctional monomers and oligomers of the ionizing radiation curable property include groups polymerizable with actinic energy such as light, electron beam and radiation. Among those, photopolymerizable functional groups are specially preferable. Examples of the photopolymerizable functional groups are a (meth)acryloyl group, vinyl group, styryl group, allyl group and other unsaturated photopolymerizable functional groups. Among those, the (meth)acryloyl group is specially preferable.

[Solvent]

The solvent is preferably a compound in which substances in the support film 22 are insoluble. Also, the solvent can be a compound for swelling the substances in the support film 22 to tighten the contact between the support layer 11 and the hard coat layer 12 in the multi-layer film 10. Furthermore, the solvent can be a compound in which an ultraviolet curable compound will be soluble or dispersible uniformly without precipitation. Two or more examples of solvents can be used in combination.

Preferred examples of solvents as dispersion medium include alcohols, ketones, esters, amides, ethers, ether esters, hydrocarbons, halogenated hydrocarbons and the like. Among those, specific examples are as follows:

alcohols (methanol, ethanol, propanol, butanol, benzyl alcohol, ethylene glycol, propylene glycol, ethylene glycol monoacetate and the like);

ketones (methyl ethyl ketone, methyl isobutyl ketone, cyclohexanone, methyl cyclohexanone and the like);

esters (methyl acetate, ethyl acetate, propyl acetate, butyl acetate, ethyl formate, propyl formate, butyl formate, ethyl lactate and the like);

aliphatic hydrocarbons (hexane, cyclohexane and the like);

halogenated hydrocarbons (methylene chloride, methyl chloroform and the like);

aromatic hydrocarbons (toluene, xylene and the like);

amides (dimethylformamide, dimethyl acetoamide, n-methylpyrrolidone and the like);

ethers (dioxane, tetrahydrofuran, ethylene glycol dimethyl ether, propylene glycol dimethyl ether and the like);

ether alcohols (1-methoxy-2-propanol, ethyl cellosolve, methyl carbinol and the like);

fluoroalcohols (compounds disposed in JP-A 8-143709, paragraph 0020, and JP-A 11-060807, paragraph 0037).

Any one of the examples of solvents can be used. Also, two or more of those can be used in a mixed state. Preferable solvents include toluene, xylene, methyl ethyl ketone, methyl isobutyl ketone, cyclohexanone, methanol, iso-propanol, butanol and the like. Solvent compositions containing a ketone solvent (methyl ethyl ketone, methyl isobutyl ketone, cyclohexanone and the like) as a main component are also preferable. A content of the ketone solvent is preferably equal to or more than 10 wt. % of the total content of the solvents contained in the curable composition. The content of the ketone solvent is more preferably equal to or more than 30 wt. % of the total of the content of the solvents.

A dry gas supply source 38 is incorporated in the dryer 32. Dry gas 37 is applied to the layer 28 by the dry gas supply source 38.

An ultraviolet radiation source 40 or lamp is incorporated in the ultraviolet irradiator 33. Ultraviolet rays 41 are applied by the ultraviolet radiation source 40 to the layer 28. The layer 28 becomes a polymer film containing a polymerized ultraviolet curable compound. Thus, it is possible to obtain the multi-layer film 10 including the hard coat layer 12 and the support layer 11 from the support film 22.

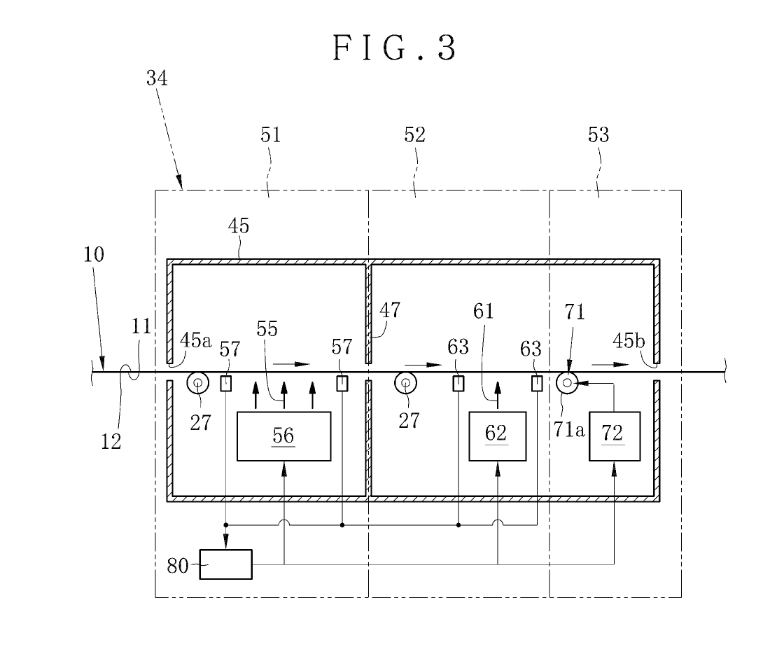

In FIG. 3, the decurling apparatus 34 has a cover body or chamber cover 45 or case. An inlet 45a and an outlet 45b are formed in the cover body 45. A moving path for the multi-layer film 10 extends through the cover body 45 from the inlet 45a to the outlet 45b. A preheating device 51, a water vapor contact device 52 and a cooling device 53 are arranged in the cover body 45 serially in the moving direction. A wall 47 is preferably used between the preheating device 51 and the water vapor contact device 52 for division. Note that the preheating device 51 may be omitted. Also, a wall may be added between the water vapor contact device 52 and the cooling device 53 for division.

[Preheating Device]

The preheating device 51 includes a preheating gas supply source 56 and a temperature/humidity sensor 57. A nozzle of the preheating gas supply source 56 discharges preheating gas 55. The temperature/humidity sensor 57 detects temperature and humidity of internal gas near to the moving path 24. The nozzle is opposed to the moving path 24. In the drawing, the preheating gas supply source 56 is directed to the support layer 11. Instead of this or in addition to this, a second preheating gas supply source 56 may be installed and directed to the hard coat layer 12 of the multi-layer film 10. Examples of the preheating gas 55 include air, and inert gases which may be nitrogen and rare gases.

[Water Vapor Contact Device]

The water vapor contact device 52 includes a water vapor source 62 and a temperature/humidity sensor 63. A nozzle of the water vapor source 62 discharges water vapor 61. The temperature/humidity sensor 63 detects temperature and humidity of internal gas near to the moving path 24. The nozzle is opposed to the support layer 11 of the multi-layer film 10 in the moving path 24. Also, a suction nozzle unit may be disposed in the water vapor contact device 52 upstream or downstream of the water vapor source 62, for suction of the water vapor 61.

[Cooling Device]

The cooling device 53 includes a transport roller 71 or rotating chill roll and a roller temperature adjuster 72. A peripheral surface 71a of the transport roller 71 supports the support layer 11 of the multi-layer film 10. The roller temperature adjuster 72 adjusts temperature of the peripheral surface 71a of the transport roller 71. A flow channel is formed through the transport roller 71 for flow of a heat conducting material. A control unit is incorporated in the roller temperature adjuster 72 for limiting the temperature of the heat conducting material in a predetermined range. The heat conducting material is circulated between the flow channel and the control unit. Examples of a material for the transport roller 71 should have high thermal conductivity, for example, aluminum, stainless steel, ceramics and the like.

A controller 80 as gas adjuster is incorporated in the decurling apparatus 34. The controller 80 reads temperature and humidity from the temperature/humidity sensors 57 and 63 in the vicinity of the moving path 24, and adjusts the temperature and humidity of the preheating gas 55 and temperature and flow rate of the water vapor 61 according to the information from the sensors. Also, the controller 80 adjusts temperature of the heat conducting material introduced by the roller temperature adjuster 72 into the transport roller 71.

The operation of the embodiment is described now. In FIG. 2, the film dispenser 23 in the multi-layer film production system 20 advances the support film 22 to the moving path 24. The support film 22 becomes the multi-layer film 10 by passing the moving path 24 and moves to the film winder 25. The film winder 25 winds the multi-layer film 10 about a spindle.

Then the coater 31 coats the support film 22 with the layer 28 in the coating step. The dryer 32 in the drying step applies the dry gas 37 to the layer 28 of the support film 22 to evaporate the solvent from the layer 28. Temperature of the dry gas 37 is equal to or higher than 10 deg. C. and equal to or lower than 150 deg. C., and preferably equal to or higher than 20 deg. C. and equal to or lower than 120 deg. C. The drying step for the layer 28 is preferably carried out until a content of the remaining solvent in the layer 28 becomes equal to or less than 0.5 wt. %.

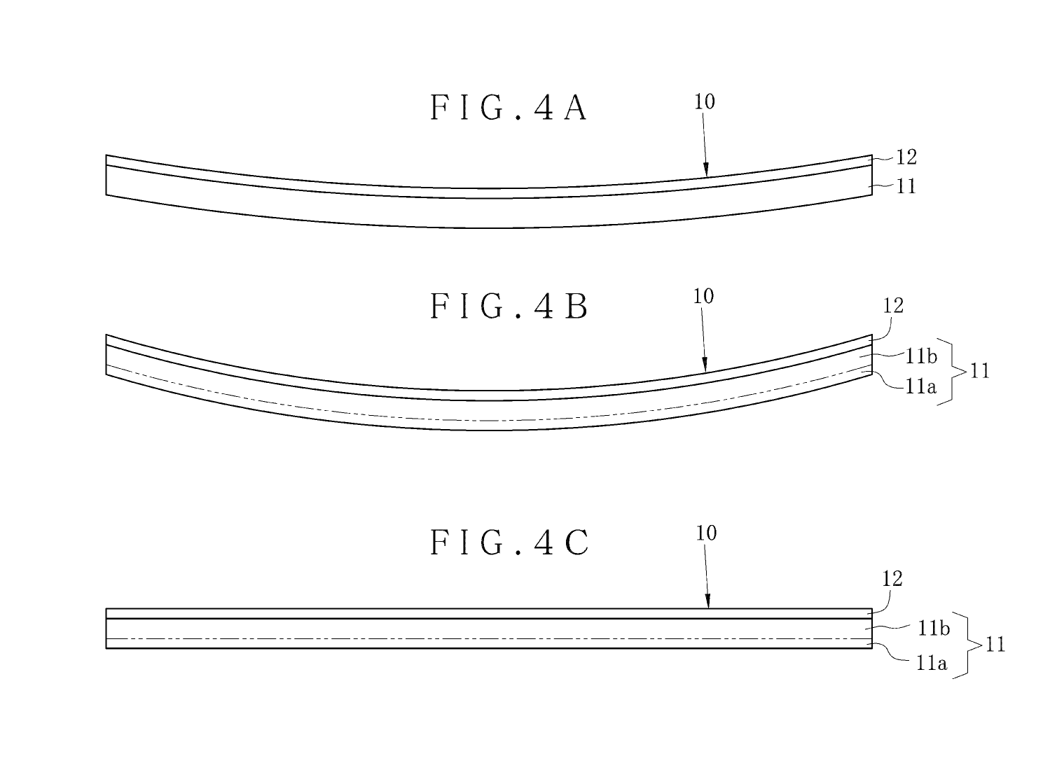

The support film 22 after the drying step is introduced in the ultraviolet irradiator 33. The ultraviolet curable compound in the layer 28 is polymerized or cured in the ultraviolet irradiator 33. As a result, the support film 22 having the layer 28 becomes the multi-layer film 10. During the polymerization, a first internal stress occurs between the hard coat layer 12 and the support layer 11 upon shrinkage and curing of the ultraviolet curable compound. A curl of the multi-layer film 10 occurs due to the first internal stress after the polymerization in a form to direct the hard coat layer 12 inwards. See FIG. 4A.

In FIG. 3, the multi-layer film 10 with the first curl is introduced in the decurling apparatus 34. The multi-layer film 10 is transported through the preheating device 51, the water vapor contact device 52 and the cooling device 53.

The preheating device 51 applies the preheating gas 55 to the multi-layer film 10. Thus, the multi-layer film 10 is preheated.

It is preferable to carry out heating of the multi-layer film 10 with the preheating gas 55 to set the temperature Tf of the compounds in the support layer 11 near the glass transition temperature Tg0 of the support layer 11 without becoming higher than the glass transition temperature Tg0. A preferable range of (Tg-Tf) is equal to or more than 30 deg. C. and equal to or less than 80 deg. C. Note that the glass transition temperature Tg0 (Tg) is the glass transition temperature of the support layer 11 after the curing and before the vapor supply step.

In the vapor supply step, the water vapor contact device 52 applies the water vapor 61 to a surface of the multi-layer film 10 having the support layer 11. A surface layer portion 11a, which appears externally on the support layer 11, has a glass transition temperature Tg1 which becomes lower than the glass transition temperature Tg0. The surface layer portion 11a comes in the rubber phase, in which its temperature is higher than the glass transition temperature Tg1. A subsurface portion 11b, which is located under the surface layer portion 11a in the support layer 11, has temperature lower than the glass transition temperature Tg0. In other words, the subsurface portion 11b remains in the glass phase. Elasticity of the surface layer portion 11a becomes lower than that of the subsurface portion 11b, to enlarge the first curl of the multi-layer film 10 further. See FIG. 4B.

Time for the vapor supply step can be in a range sufficient for decurling effectively for the purpose, and is preferably equal to or less than 10 seconds, and more preferably equal to or less than 2 seconds.

The water vapor 61 can be any one of saturated vapor and superheated vapor. The temperature of the water vapor 61 is preferably in a range equal to or higher than 70 deg. C. and equal to or lower than 130 deg. C., and more preferably in a range equal to or higher than 100 deg. C. and equal to or lower than 120 deg. C. The humidity of the water vapor 61 is preferably in a range equal to or higher than 30% RH and equal to or lower than 100% RH, and more preferably in a range equal to or higher than 60% RH and equal to or lower than 90% RH.

In FIG. 3, the multi-layer film 10 introduced in the cooling device 53 is supported by the transport roller 71 in contact with the support layer 11 while the temperature of the peripheral surface 71a is conditioned in a predetermined range. As a result, the cooling device 53 cools the support layer 11 having the subsurface portion 11b and the surface layer portion 11a of the rubber phase. During the cooling, a second internal stress occurs in the support layer 11 between the surface layer portion 11a and the subsurface portion 11b because the surface layer portion 11a is shrunk more than the subsurface portion 11b. Thus, there occurs a change in the multi-layer film 10 to correct the first curl with the second internal stress. Finally, the first curl can be removed. See FIG. 4C.

Time for the cooling step is preferably equal to or more than 1 second and equal to or less than 30 seconds, and more preferably equal to or more than 5 seconds and equal to or less than 20 seconds. A temperature decrease ΔT in the temperature of the multi-layer film 10 in the cooling step is equal to or more than 10 deg. C., and preferably equal to or more than 30 deg. C. An upper limit of the temperature decrease ΔT is not limited, but is preferably equal to or less than 90 deg. C. It is preferable to cool the multi-layer film 10 until its temperature comes down to 50 deg. C. or lower within 2 seconds from the start of the cooling step. Thus, it is possible to set the cooling speed of the support layer 11 in the cooling step at such a level as to carry out a first decurling step. Note that the cooling speed of the support layer 11 in the cooling step is not limited, but is preferably equal to or more than 0.33 deg. C. per second.

A temperature difference T11a-T71a between the temperature T71a of the peripheral surface 71a and the temperature T11a of the surface layer portion 11a is equal to or more than 10 deg. C. and equal to or less than 100 deg. C., and preferably equal to or more than 40 deg. C. and equal to or less than 100 deg. C. The temperature T11a is equal to or more than 70 deg. C. and equal to or less than a melting point of substances in the support layer 11, and preferably equal to or more than 80 deg. C. and equal to or less than 110 deg. C. The temperature T71a is equal to or more than 0 deg. C. and equal to or less than 80 deg. C., and preferably equal to or more than 10 deg. C. and equal to or less than 50 deg. C.

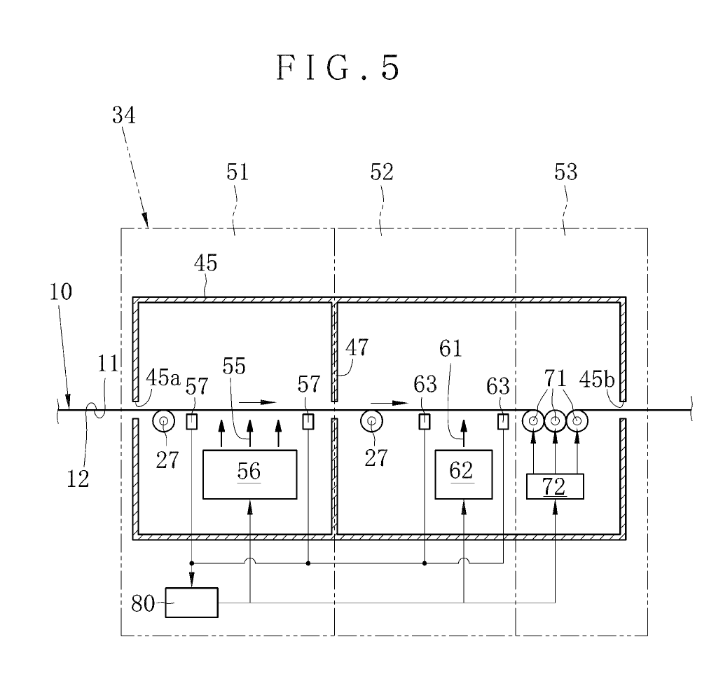

In the embodiment, the transport roller 71 is single. However, a plurality of the transport rollers 71 may be arranged in the moving direction for transport. In the above embodiment, the transport roller 71 supports the surface layer portion 11a upwards for transport. Instead, the multi-layer film 10 can contact the periphery of the transport rollers 71 arcuately to move longitudinally. See FIG. 5. As the peripheral surface 71a of the transport rollers 71 is conditioned at a temperature in a predetermined range, the support layer 11 with the surface layer portion 11a and the subsurface portion 11b can be cooled quickly in a reliable manner.

In FIG. 5, the three transport rollers 71 are used for cooling, among which first and third rollers contact the support layer 11, and a second roller contacts the hard coat layer 12. In order to cool the support layer 11, it is preferable to control the first and third rollers at a lower temperature than the second. Also, it is possible to operate the second roller for transport without cooling, and operate the first and third for cooling and transport.

Also, a nip roller opposed to the transport roller 71 can be used in the cooling device 53 along the moving path 24. It is possible reliably to cool the support layer 11 quickly by the combined use of the transport roller 71 and the nip roller.

In the embodiment, the transport roller as rotating chill roll contacts the support layer 11. Alternatively, dry cooling gas can be blown to the support layer 11.

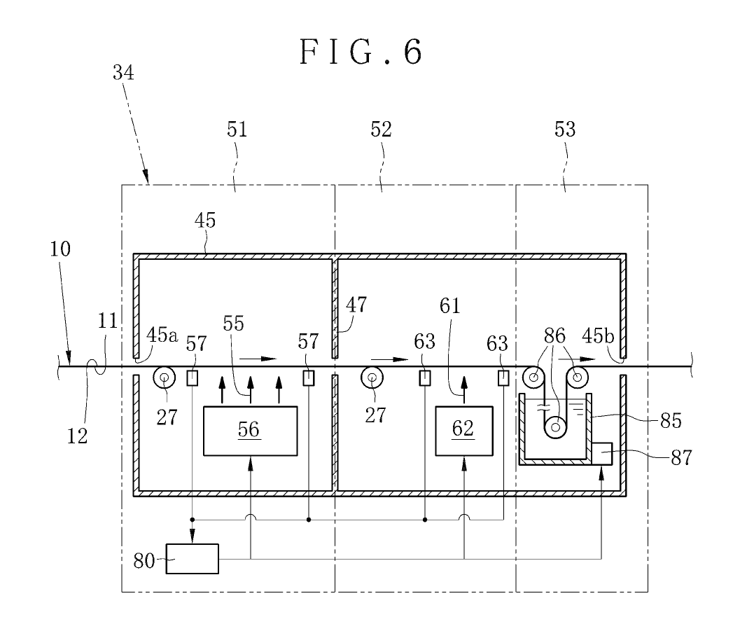

In FIG. 6, a contact water reservoir 85 and a guide roller 86 are preferably incorporated in the cooling device 53. The contact water reservoir 85 stores water. The guide roller 86 guides the multi-layer film 10 into the water in the contact water reservoir 85 for water contact. A temperature adjuster 87 may be added in the contact water reservoir 85 for maintaining temperature of the water in a constant range. The water temperature of the contact water reservoir 85 is equal to or higher than 0 deg. C. and equal to or lower than 60 deg. C., and preferably equal to or higher than 10 deg. C. and equal to or lower than 40 deg. C. Also, shower water can be used and supplied to the multi-layer film 10 instead of the water contact of the multi-layer film 10. A coating of water may be applied to the multi-layer film 10. Mist of water may be applied to the multi-layer film 10. It is possible to combine the reservoir water, shower water, coating and mist. A combination of the shower water and reservoir water is specially preferable. A sequence of those is preferably the shower water and then the reservoir water.

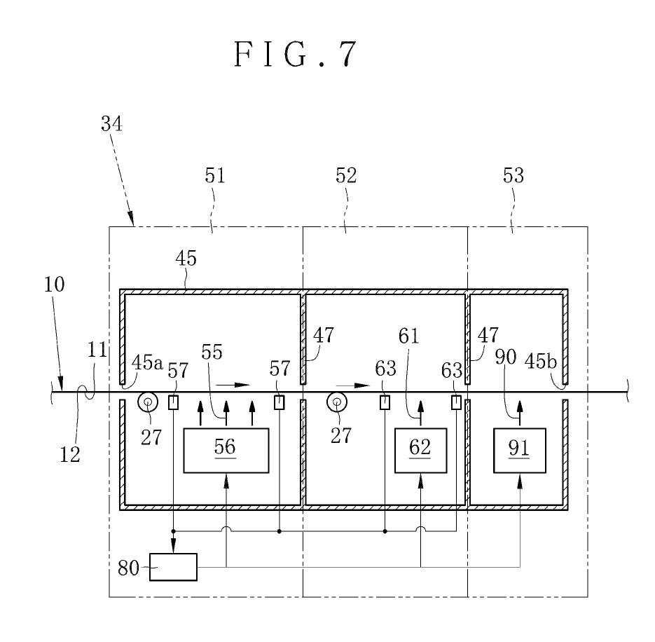

In FIG. 7, a construction with a cooling gas supply source 91 is illustrated. The cooling gas supply source 91 in the cooling device 53 applies cooling gas 90 to the multi-layer film 10. The cooling gas supply source 91 is controlled by the controller 80 and keeps the cooling gas 90 conditioned at a predetermined temperature, humidity and flow rate. The temperature of the cooling gas 90 is preferably in a range equal to or higher than 0 deg. C. and equal to or lower than 80 deg. C., and more preferably in a range equal to or higher than 10 deg. C. and equal to or lower than 50 deg. C. The humidity of the cooling gas 90 is preferably in a range equal to or higher than 10% RH and equal to or lower than 90% RH, and more preferably in a range equal to or higher than 50% RH and equal to or lower than 90% RH. Examples of the cooling gas 90 include air, and inert gases which may be nitrogen and rare gases. Also, a specific cover body or chamber cover or case may be installed and filled with the cooling gas 90, so as to transport the multi-layer film 10 through the cover body for applying the cooling gas 90 to the multi-layer film 10.

In short, it is possible in the cooling step to use moist gas (wet gas), liquid water, mist of water and the like as coolant for the multi-layer film 10. Water molecules are preferably used to cool the multi-layer film 10 in the cooling step.

It is likely in the coating step that an impregnated layer is formed with the support film 22 as a result of impregnation of the ultraviolet curable compound in the coating solution to the support film 22. The impregnated layer can be considered as a portion of the support layer 11.

If fold creases occur upon contact with a transport roller, the following methods can be preferably used for preventing fold creases.

The fold creases are wrinkles protruding from the surface of the hard coat layer 12 of the multi-layer film 10 and extending in its moving direction. When the support layer 11 of an expanded or shrunk state contacts any of the transport rollers 27, fold creases are created.

The support layer 11 expands upon a transition from the glass phase to the rubber phase, and also upon contact with the transport roller 27 at a higher temperature (for example, by 20-30 deg. C.) than that of the support layer 11. The support layer 11 shrinks upon a transition from the rubber phase to the glass phase, and also upon contact with the transport roller 27 at a lower temperature (for example, by 20-30 deg. C.) than that of the support layer 11.

Processes of occurrence of the fold creases or wrinkles are hypothetically described as follows.

[First Process of Occurrence of Fold Creases]

A contacting portion of the support layer 11 in contact with the transport roller 27 is difficult to expand in the width direction due to friction with a peripheral surface of the transport roller 27. The contacting portion expands in a thickness direction, so that the multi-layer film 10 will bend erectly from the peripheral surface of the transport roller 27. As a result, fold creases or wrinkles occur in the multi-layer film 10.

[Second Process of Occurrence of Fold Creases]

As the support layer 11 expands due to a contact on the transport roller, a first portion of the multi-layer film 10 upstream of the transport roller has a width different from a width of a second portion of the multi-layer film 10 downstream of the transport roller. Thus, fold creases or wrinkles occur on the multi-layer film 10 upon occurrence of inner stress due to the width difference.

The Youngs modulus of the support layer 11 in the rubber phase is lower than that in the glass phase. It is difficult to maintain the form of the support layer 11 in the rubber phase upon occurrence of external force or internal stress. Thus, fold creases or wrinkles are likely to occur in the multi-layer film 10 when the support layer 11 is in the rubber phase, because of expansion or thermal expansion of the support layer 11.

In the decurling apparatus 34, a portion of the support layer 11 in the rubber phase is preferably transported by a method of a non-contact state with a transport roller. Examples of the method include a floating transport method of applying floating gas to the multi-layer film 10 upwards, a tentering method of clamping web edge portions of the multi-layer film 10 to move in a tentering machine such as a clip tentering machine, and a roller method of supporting only a portion of the support layer 11 in the glass phase to transport by use of a transport roller.

To shorten time during which the support layer 11 is in the rubber phase, it is preferable in the cooling device 53 to cool the support layer 11 of the rubber phase until the support layer 11 comes in the glass phase. A method of this cooling is application of cooling gas to the multi-layer film 10 being transported. Also, the cooling gas may be used as floating gas.

It is possible in the preheating device 51 or the cooling device 53 to carry out dehumidification to shorten time of the rubber phase of the support layer 11. In the dehumidification, conditioned gas in which fluid vapor is adjusted is blown to the support layer 11 to eliminate molecules of water from the support layer 11. Also, a shielding plate can be disposed at an outlet of the preheating device 51 or an inlet of the cooling device 53, to prevent entry of the water vapor 61 from the water vapor contact device 52 into the preheating device 51 or the cooling device 53.

It is preferable to add the anti-condensation control to each of the steps carried out before and after the vapor supply step. In the anti-condensation control, temperature of the multi-layer film 10 or a dew point of the atmosphere around the multi-layer film 10 is adjusted to set the temperature higher than the dew point.

The moving speed of the multi-layer film 10 is equal to or more than 20 m/min, and preferably equal to or more than 30 m/min. An upper limit of the moving speed of the multi-layer film 10 is not limited, but can be preferably equal to or less than 70 m/min.

[Cellulose Acylates]

A preferable cellulose acylate is cellulose triacetate (TAC). Preferable examples of cellulose acylates satisfy all of the conditions I-III in relation to a degree of substitution of the acyl group formed by substituting hydroxy groups in cellulose, as follows:

2.5≦A+B≦3.0 Condition I

0≦A≦3.0 Condition II

0≦B≦2.9 Condition III

where A and B represent the degree of substitution of the acyl group. A represents a degree of substitution of an acetyl group. B represents a total degree of substitution of acyl groups having 3-22 carbon atoms. Preferably, the cellulose triacetate should include 90 wt. % or more of particles of 0.1-4 mm.

The cellulose is constructed by glucose units making a beta-1,4 bond, and each glucose unit has a liberated hydroxy group at 2, 3 and 6-positions. Cellulose acylate is a polymer in which part or whole of the hydroxy groups are esterified so that the hydrogen is substituted by acyl groups having two or more carbon atoms. The degree of substitution for the acyl groups in cellulose acylate is a degree of esterification at 2, 3 or 6-position in cellulose. (When 100% of the hydroxy group at the same position is substituted, the degree of substitution at this position is 1.)

The total degree of substitution DS2+DS3+DS6 for the acyl groups at 2, 3 or 6-position is in the range of 2.00-3.00, preferably 2.22-2.90, and in particular preferably 2.40-2.88. Further, a ratio DS6/(DS2+DS3+DS6) is preferably 0.28 or more, and particularly 0.30 or more, and especially in the range of 0.31-0.34. The signs DS2, DS3 and DS6 are degrees of substitution for the acyl groups at respectively 2, 3 and 6-positions in hydroxy groups in the glucose unit.

The cellulose acylate in the invention may contain an acyl group of a single example, but can contain acyl groups of two or more examples. If two or more acyl groups are contained, one of the plural acyl groups should be preferably an acetyl group. Let DSA be a total degree of substitution for the acetyl groups. Let DSB be a total degree of substitution for acyl groups at 2, 3 or 6-position different from the acetyl groups. The value DSA+DSB is preferably in the range of 2.22-2.90, and particularly in the range of 2.40-2.88. Further, the DSB is preferably at least 0.30, and especially at least 0.70. Furthermore, in the DSB, the percentage of a substituent group at 6-position is preferably at least 20%, particularly at least 25%, especially at least 30%, and most especially at least 33%. Further, the value DSA+DSB at 6-position is at least 0.75, particularly at least 0.80, and especially at least 0.85. Cellulose acylate satisfying those conditions can be used to prepare a solution or dope having a preferable solubility. Especially when a chlorine-free type organic solvent is used, the adequate dope can be prepared. Also, the dope can be prepared so as to have a low viscosity and higher filterability.

A raw material from which cellulose for the cellulose acylates is produced may be any one of linter (cotton linter) and pulp.

Examples of acyl groups in cellulose acylates having two or more carbon atoms are not limited, and can be aliphatic groups, aryl groups, and the like. For example, cellulose acylates may be alkyl carbonyl esters, alkenyl carbonyl esters, aromatic carbonyl esters, aromatic alkyl carbonyl esters, and the like of cellulose, and can further contain a substituent group. Preferable examples of groups include: propionyl, butanoyl, pentanoyl, hexanoyl, octanoyl, decanoyl, dodecanoyl, tridecanoyl, tetradecanoyl, hexadecanoyl, octadecanoyl, iso-butanoyl, tert-butanoyl, cyclohexane carbonyl, oleoyl, benzoyl, naphthyl carbonyl, and cinnamoyl. Among those, more preferable groups are propionyl, butanoyl, dodecanoyl, octadecanoyl, tert-butanoyl, oleoyl, benzoyl, naphthyl carbonyl, and cinnamoyl. Further, still more preferable groups are propionyl and butanoyl.

It is possible to add fine particles in the support layer 11. Surface roughness with peaks and valleys can be imparted to the surface of the support layer 11. Also, internal scattering property can be imparted to the support layer 11. The multi-layer film 10 can have anti-reflection property.

Fine particles may be organic or inorganic. If there is small irregularity in the particle diameter, irregularity in the dispersibility is small so that the haze value can be predetermined easily.

Examples of inorganic fine particles usable in the invention include silicon oxide, titanium oxide, aluminum oxide, tin oxide, indium oxide, indium tin oxide (ITO), zinc oxide, zirconium oxide, antimony oxide, magnesium oxide, calcium carbonate, talc, clay, sintered kaolin, sintered calcium silicate, hydrated calcium silicate, aluminum silicate, magnesium silicate, calcium phosphate, and composite oxide thereof.

An average diameter of primary particles among the fine particles is 3-12 microns, preferably 5-12 microns, and more preferably 6-10 microns. A content of the fine particles in the support layer 11 is 0.1-20 wt. %, and preferably 0.1-18 wt. %. If the support layer 11 is constituted by a plurality of sub-layers, a first sub-layer positioned as an outermost layer can preferably contain the fine particles. The fine particles satisfying the condition of the average diameter are effective in obtaining an anti-reflection film capable of preventing glare of a surface for use in a display panel, having a high contrast ratio, and having good appearance of a black color. Should the average diameter be less than 3 microns, unevenness of the surface is so fine as to strengthen diffuse reflection of reflected light, to result in an anti-reflection film having too white the appearance of the display panel, and having poor appearance of the black color. Should the average diameter be more than 12 microns, the contrast ratio decreases.

In the embodiment, the hard coat layer 12 is overlaid on the support layer 11 in the multi-layer film 10. However, the multi-layer film 10 may have other structures. For example, the multi-layer film 10 can include the support layer 11, the hard coat layer 12 overlaid on the support layer 11, and a low refractive index layer overlaid on the hard coat layer 12.

Forming the low refractive index layer having a lower refractive index than the hard coat layer can impart an anti-reflection property to the multi-layer film 10. If a difference in the refractive index between the low refractive index layer and the hard coat layer is too small, the anti-reflection property will be low. If the difference is too large, a color balance of reflected light may be excessive. The difference in the refractive index is preferably equal to or more than 0.01 and equal to or less than 0.30, and more preferably equal to or more than 0.05 and equal to or less than 0.20. The low refractive index layer can be formed from a low refractive index material, of which an example is a low refractive index binder. Also, the low refractive index layer can be formed from a binder and fine particles added thereto.

A preferable example of low refractive index binder is fluorine-containing copolymer. The fluorine-containing copolymer preferably contains a repeating unit derived from a fluorine-containing vinyl monomer and a repeating unit for imparting cross linking property.

The refractive index of the low refractive index layer is preferably from 1.20 to 1.46, more preferably from 1.25 to 1.42, still more preferably from 1.30 to 1.38. The thickness of the low refractive index layer is preferably from 50 to 150 nm, more preferably from 70 to 120 nm.

The low refractive index layer preferably contains fine particles at a smaller content than the hard coat layer. The blending amount of the fine particles is preferably from 1 to 100 mg/m², more preferably from 1 to 80 mg/m², still more preferably from 1 to 70 mg/m². If the blending amount should be too small, the effect of improving the scratch resistance may decrease. If the blending amount should be excessively large, fine irregularities are generated on the low refractive index layer surface and the appearance or the integrated reflectance may deteriorate.

Fine particles contained in the low refractive index layer can be inorganic fine particles, hollow inorganic fine particles, and hollow organic fine particles, and preferably have a low refractive index. Among those, hollow inorganic fine particles are more preferable. Examples thereof include a silica fine particle and a hollow silica fine particle.

The average particle diameter of the fine particles is preferably from 30 to 100%, more preferably from 30 to 80%, still more preferably from 35 to 70% as large as the thickness of the low refractive index layer. In other words, when the thickness of the low refractive index layer is 100 nm, the particle diameter of the fine particles is preferably from 30 to 100 nm, more preferably from 30 to 80 nm, still more preferably from 35 to 70 nm.

The hard coat layer 12 can contain fine particles with an average particle diameter of 3.0-12.0 microns, preferably 5-8 microns for the purpose of imparting internal dispersibility or a profile with surface roughness, such as fine particles of an inorganic compound or resin. Note that the average particle diameter of the fine particles in the hard coat layer 12 is preferably 3 microns or less for the purpose of the internal dispersibility or surface roughness if the above-described fine particles in the transparent support impart the internal dispersibility or surface roughness. It is also preferable not to use inorganic fine particles with an average particle diameter of 1 micron or less. This is because of lowering stability of the coating solution for the hard coat layer 12 despite effects for adjusting a refractive index of the hard coat layer 12.

For the surface roughness of the hard coat layer 12, a centerline roughness average (Ra) is preferably equal to or more than 0.05 micron and equal to or less than 0.20 micron, and more preferably equal to or more than 0.05 micron and equal to or less than 0.15 micron. A peak spacing (Sm) or peak-to-peak distance of the surface is preferably equal to or more than 10 microns and equal to or less than 150 microns, and more preferably equal to or more than 50 microns and equal to or less than 150 microns, and still more preferably equal to or more than 60 microns and equal to or less than 120 microns.

### Example

[Sample 1]

The multi-layer film production system 20 in FIG. 2 was operated. The support film of a flat form was introduced to the coater 31, the dryer 32 and the ultraviolet irradiator 33 in series, to produce a multi-layer film having a support layer of the support film with a thickness of 80 microns and a hard coat layer of a thickness of 9 microns. There occurred a curl with the multi-layer film from the ultraviolet irradiator 33 in a form to direct the hard coat layer inwards. An amount of a curvature of the curl of the multi-layer film was 20.9 m⁻¹. Definition and determination of the curvature of the curl of the multi-layer film will be described later in detail.

In the decurling apparatus 34 of FIG. 7, the multi-layer film 10 with a curl was introduced into the preheating device 51, the water vapor contact device 52 and then the cooling device 53. The preheating gas supply source 56 applied the preheating gas 55 to the multi-layer film 10 to set its temperature T51 at 88 deg. C. The water vapor source 62 applied water vapor to the surface of the support layer. In the vapor supply step, gas containing water vapor was used and conditioned at the temperature T52 of 106 deg. C. and humidity AH52 of 570 g/m³. Time P52 required for the vapor supply step was 1.40 seconds. The temperature Tf52 of the multi-layer film 10 at an outlet of the water vapor contact device 52 was 99 deg. C. In the cooling step, the cooling device 53 cooled the multi-layer film 10. Cooling gas was applied to both surfaces of the multi-layer film 10 of the temperature Tf52 for a predetermined time P53. The cooling gas was conditioned at the temperature T53 of 20 deg. C. and a relative humidity H of 32% RH. A cooling speed for the multi-layer film 10 in the cooling step was kept constant. A flow rate V1 of the cooling gas was 5.0 m/sec. The time P53 was 10 seconds. The temperature Tf53 of the multi-layer film 10 upon lapse of 2 seconds from the start of the cooling step was 46 deg. C. Thus, the multi-layer film 10 was decurled.

[Samples 2-12]

In Samples 2-5 and 10, Sample 1 was repeated for decurling, with differences in that specific parameters were set at values in Table 1. In Samples 6 and 7, Sample 1 was repeated for decurling, with differences in that cooling gas was applied to the support layer and that the parameters were set at values in Table 1.

In Samples 8 and 11, Sample 1 was repeated for decurling, with differences in that the multi-layer film in the cooling device 53 in FIG. 6 was guided into water in the water reservoir conditioned at the temperature T53 and that the parameters were set at values in Table 1.

In Samples 9 and 12, Sample 1 was repeated for decurling, with differences in that the transport roller in the cooling device 53 in FIG. 3 was conditioned at a temperature T53 of the peripheral surface, to cool the surface of the support layer of the multi-layer film during transport, and that the parameters were set at values in Table 1.

TABLE 1

| | Vapor supply step | | | |
|---|---|---|---|---|
| | | T52 (deg. | | Tf52 (deg. |
| | AH52 (g/m³) | C.) | P52 (sec) | C.) |
| Sample 1 | 570 | 106 | 1.40 | 99 |
| Sample 2 | 570 | 106 | 1.37 | 98 |
| Sample 3 | 570 | 106 | 1.48 | 98 |
| Sample 4 | 570 | 106 | 1.33 | 98 |
| Sample 5 | 570 | 106 | 1.30 | 99 |
| Sample 6 | 570 | 106 | 1.38 | 98 |
| Sample 7 | 570 | 106 | 1.37 | 99 |
| Sample 8 | 570 | 106 | 1.17 | 97 |
| Sample 9 | 570 | 106 | 1.33 | 98 |
| Sample 10 | 570 | 106 | 2.00 | 97 |
| Sample 11 | 570 | 106 | 2.00 | 98 |
| Sample 12 | 570 | 106 | 2.00 | 97 |

| | Cooling step | | | | | |
|---|---|---|---|---|---|---|
| | | T53 | | | | Tf53 |
| | | (deg. | | V1 | P53 | (deg. |
| | Surface | C.) | H (% RH) | (m/sec) | (sec) | C.) |
| Sample 1 | Both | 20 | 32 | 5 | 10 | 46 |
| Sample 2 | Both | 10 | 30 | 5 | 10 | 42 |
| Sample 3 | Both | 30 | 30 | 10 | 10 | 45 |
| Sample 4 | Both | 20 | 70 | 5 | 10 | 45 |
| Sample 5 | Both | 10 | 90 | 5 | 10 | 41 |
| Sample 6 | One | 19 | 32 | 5 | 10 | 47 |
| Sample 7 | One | 9 | 29 | 5 | 10 | 43 |
| Sample 8 | Both | 20 | — | — | 5 | 20 |
| Sample 9 | One | 20 | 30 | — | 5 | 21 |
| Sample | Both | 25 | 50 | 0 | 10 | 57 |
| 10 | | | | | | |
| Sample | Both | 50 | — | — | 5 | 51 |
| 11 | | | | | | |
| Sample | One | 50 | 15 | — | 5 | 54 |
| 12 | | | | | | |

| | L (mm) | H (mm) | C (m⁻¹) |
|---|---|---|---|
| Sample 1 | 146 | 10 | 5.2 |
| Sample 2 | 146 | 10 | 5.4 |
| Sample 3 | 147 | 9 | 5.1 |
| Sample 4 | 147 | 9 | 5.0 |
| Sample 5 | 146 | 10 | 5.2 |
| Sample 6 | 147 | 9 | 5.0 |
| Sample 7 | 147 | 8 | 4.9 |
| Sample 8 | 147 | 8 | 4.8 |
| Sample 9 | 147 | 9 | 5.0 |
| Sample 10 | 146 | 11 | 5.5 |
| Sample 11 | 141 | 20 | 7.9 |
| Sample 12 | 143 | 17 | 7.1 |

[Measurement of the Curvature of the Curl]

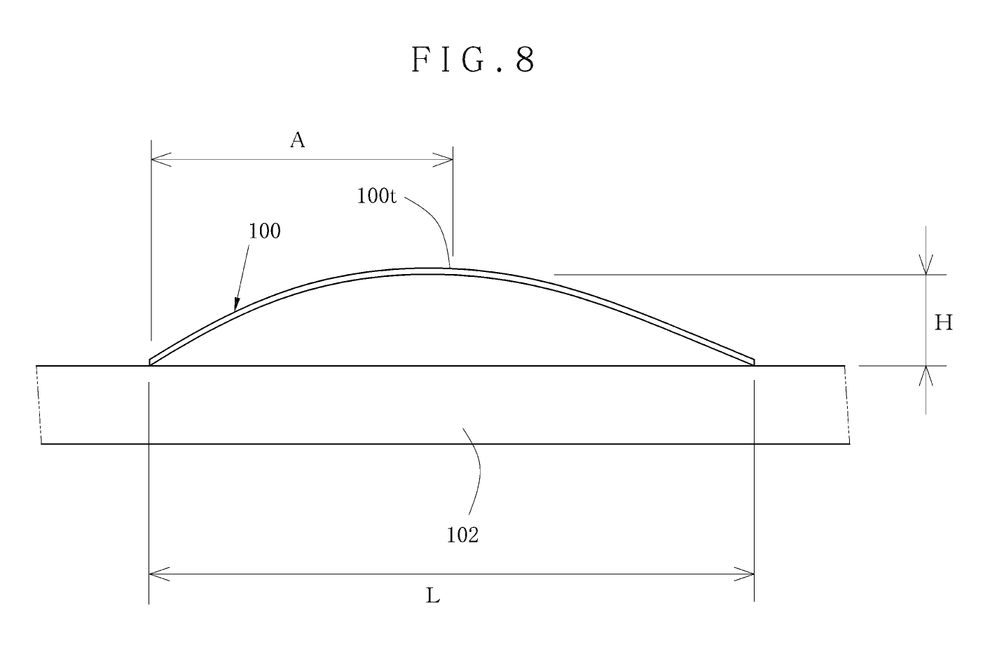

The multi-layer film discharged from the decurling apparatus was cut into strips one of which had a size of 5 mm in the longitudinal direction of the web. The strip was also slitted at an interval of 150 mm in the web width direction of the multi-layer film into film pieces 100 each of which was 5×150 mm large. See FIG. 8. Then one of the film pieces 100 was placed on a horizontally disposed flat support table 102 by directing the hard coat layer downwards. The film piece 100 as viewed in an elevation was arcuate convexly up from the support table 102. Let L be a length of a line segment defined between end points of the film piece 100 in the web width direction. Let H be a height of a highest film point 100t of the film piece 100 with reference to the support table 102. The length L and the height H were measured. Then an amount C of the curvature of the curl of the film piece 100 was calculated in the web width direction according to the length L and the height H.

In conclusion, it was found from the results of Samples 1-12 that time required for decurling the multi-layer film 10 in the invention could be shorter than that according to the prior art.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A decurling method for a continuous multi-layer film having at least first and second layers and having a curling tendency to direct said first layer inwards, comprising step of:
moving said multi-layer film longitudinally;
during movement of said multi-layer film, supplying water vapor to contact a surface layer portion in said second layer, to apply heat to set said surface layer portion at a higher temperature than a glass transition temperature thereof;
during movement of said multi-layer film and immediately after said vapor supply step, cooling said multi-layer film of which said surface layer portion is set at said higher temperature, so as to set temperature of said multi-layer film at 50 deg. C. or lower within 2 seconds from a start thereof.

2. A decurling method as defined in claim 1, wherein said second layer is a support layer, and said first layer is a hard coat layer overlaid on said support layer.

3. A decurling method as defined in claim 1, wherein in said cooling step, said second layer is cooled for said multi-layer film.

4. A decurling method as defined in claim 3, wherein in said cooling step, cooling gas is applied to said surface layer portion.

5. A decurling method as defined in claim 4, wherein said cooling gas contains water vapor.

6. A decurling method as defined in claim 3, wherein in said cooling step, water molecules are used to cool said multi-layer film.

7. A decurling method as defined in claim 1, wherein in said cooling step, cooling liquid is caused to contact said surface layer portion.

8. A decurling method as defined in claim 7, wherein said cooling liquid is water.

9. A decurling method as defined in claim 7, wherein in said cooling step, a liquid reservoir storing cooling liquid is used, and said multi-layer film is introduced into said cooling liquid in said liquid reservoir by a guide roller.

10. A decurling method as defined in claim 3, wherein in said cooling step, said multi-layer film is moved by a transport roller having a peripheral surface for supporting said surface layer portion;
temperature of said peripheral surface is set lower than temperature of said surface layer portion by a value equal to or more than 10 deg. C. and equal to or less than 90 deg. C.

11. A film production method for a continuous multi-layer film having at least first and second layers and having a curling tendency to direct said first layer inwards, comprising step of:
moving said multi-layer film longitudinally;
during movement of said multi-layer film, supplying water vapor to contact a surface layer portion in said second layer, to apply heat to set said surface layer portion at a higher temperature than a glass transition temperature thereof;
during movement of said multi-layer film and immediately after said vapor supply step, cooling said multi-layer film of which said surface layer portion is set at said higher temperature, so as to set temperature of said multi-layer film at 50 deg. C. or lower within 2 seconds from a start thereof.

12. A decurling apparatus for a continuous multi-layer film having at least first and second layers and having a curling tendency to direct said first layer inwards, comprising:
a cover body for covering a moving path through which said multi-layer film is moved longitudinally;
a water vapor source, contained in said cover body, for supplying water vapor to contact a surface layer portion in said second layer, to apply heat to set said surface layer portion at a higher temperature than a glass transition temperature thereof;
a cooling device, contained in said cover body, disposed downstream of said water vapor source adjacently, for cooling said multi-layer film of which said surface layer portion is set at said higher temperature, so as to set temperature of said multi-layer film at 50 deg. C. or lower within 2 seconds from a start thereof.

13. A decurling apparatus as defined in claim 12, wherein said cooling device cools said second layer for said multi-layer film.

14. A decurling apparatus as defined in claim 13, wherein said cooling device applies cooling gas to said surface layer portion.

15. A decurling apparatus as defined in claim 14, wherein said cooling device includes:
a cooling gas supply source for discharging said cooling gas;
a gas adjuster for adjusting temperature and humidity of said cooling gas.

16. A decurling apparatus as defined in claim 13, wherein said cooling device includes:
a transport roller, having a peripheral surface, for supporting said surface layer portion and moving said multi-layer film;
a controller for setting temperature of said peripheral surface lower than temperature of said surface layer portion by a value equal to or more than 10 deg. C. and equal to or less than 90 deg. C.

17. A decurling apparatus as defined in claim 12, wherein said cooling device includes:
a liquid reservoir for storing cooling liquid;
a guide roller for introducing said multi-layer film into said cooling liquid in said liquid reservoir.
